(19) United States
(12) Patent Application Publication
(10) Pub. No.: US 2016/0123130 A1
(43) Pub. Date: May 5, 2016

(54) Borehole Tool

(71) Applicant: Schlumberger Technology Corporation, Sugar Land, TX (US)

(72) Inventors: Abderrhamane Ounadjela, Yokohama-shi (JP); Henri-Pierre Valero, Yokohama-shi (JP); Jean-Christophe Auchere, Shibuya-ku (JP); Olivier Moyal, Clamart (FR)

(21) Appl. No.: 14/927,381

(22) Filed: Oct. 29, 2015

Related U.S. Application Data
(60) Provisional application No. 62/075,215, filed on Nov. 4, 2014.

(51) Int. Cl. E21B 47/00; G01V 3/20; E21B 47/01

(52) U.S. Cl. CPC E21B 47/00; E21B 47/01; G01V 3/20

(57) ABSTRACT

A borehole tool used in a borehole comprises a tool body, a plurality of arms connected to the tool body so as to be movable radially relative thereto between a closed position and an open position, and a plurality of pads with a totally rounded outer shape. Each of the pads is mounted on each movable portion of the arms so as to be rotatable about a radial axis relative to the tool body according to the arm movement between the closed position and the open position.

### CROSS-REFERENCE TO RELATED APPLICATIONS

This application (claims the benefit of a related U.S. Provisional Application Ser. No. 61/075,215) filed 4 Nov. 2014, entitled “OVOID SENSOR FRAME TO MATCH BOREHOLE SURFACE BY ROTATION,” to Abderrhamane OUNADJELA et al., the disclosure of which is incorporated by reference herein in its entirety.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The present disclosure relates generally to borehole tools used in wellsite operations. In particular, the present disclosure relates to a wireline logging imager tool with pads for measurements in boreholes.

In a wireline logging business, there are various types of borehole logging tools with one or more pads in contact with a formation or casing for measurements in the borehole, such as a logging tool using a single pad rotating about the longitudinal axis of the tool body in borehole and a logging tool using plural pads mounted on arms connected to the tool body. Examples of such tools are found in U.S. Pat. No. 4,862,090, U.S. Pat. No. 6,191,588, U.S. Patent Application Publication No. US-2007/0193776-A1, U.S. Patent Application Publication No. US-2007/0290689-A1, and in the Formation Micro-Scanner (FMS™), the Fullbore Formation MicroImager (FMI™) and the Oil-Based Mud Imager (OBMI™) tools of Schlumberger, the Electrical Micro Scanner (EMS™) of Halliburton and the Simultaneous Acoustic and Resistivity (STAR™) Imager of Baker Atlas.

As will become apparent from the following description and discussion, the present disclosure provides borehole tools with pads used in a borehole which are capable of improving circumferential coverage according to the azimuth (orientation) with respect to the longitudinal axis of the borehole, while maintaining smooth movements of the tool along the longitudinal axis of the borehole even when being used in deviated wells.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect of the present disclosures, a borehole tool used in a borehole comprises a tool body, a plurality of arms connected to the tool body so as to be movable radially relative thereto between a closed position and an open position, and a plurality of pads with a rounded outer shape. Each of the pads is mounted on a respective movable portion of the arms so as to be rotatable about a radial axis relative to the tool body according to the arm movement between the closed position and the open position.

The plurality of pads may be adjacently arranged so as to provide different circumferential coverage according to the azimuth with respect to the longitudinal axis of the borehole.

The total outer shape of the plurality of pads at the closed position may be an almost ovoid or prolate spheroidal shape. At least one of the number and shape of pads may be determined by the range of internal size of the borehole, the overlap percentage of coverage between the adjacent pads, the outer size of borehole tool, or conditions or constraints of measuring with a sensor installed on the pad. The plurality of pads may be adjacently arranged such that each of the pads is located at different angle range in the circumferential direction about the longitudinal axis of the tool body. Two or more sets of the plurality of pads may be arranged to provide different coverage geometry.

The plurality of pads may be rotated synchronously with the arm movement or independently from the arm movement. The plurality of pads may be rotated synchronously with each other or independently from each other. The plurality of arms may be moved synchronously with each other or independently from each other. The plurality of pads may be rotated in the same rotating direction of clockwise or counterclockwise about the radial axis. The plurality of pads may be rotated by using a hydraulic controlling mechanism, an electrical motor or a spring, and the plurality of arms may be moved by using a hydraulic controlling mechanism, an electrical motor or a spring.

Advantages and novel features of the disclosures will be set forth in the description which follows or may be learned by those skilled in the art through reading the materials herein.

### BRIEF DESCRIPTION OF THE DRAWINGS

Embodiments of seal assemblies and apparatuses having the same according to the disclosures herein are described with reference to the following figures. The same numbers are used throughout the figures to reference like features and components.

FIG. 1 is a schematic view of a borehole tool;

FIGS. 2A-2C are schematic side views of a borehole tool according to one embodiment of the disclosures herein;

FIGS. 3A-3C are schematic side views of a borehole tool according to another embodiment of the disclosures herein;

FIG. 4 is a schematic view of a theoretical model of pad elements for designing the outer surface thereof.

### DETAILED DESCRIPTION

Illustrative embodiments and aspects of the present disclosure are described below. In the interest of clarity, not all features of an actual implementation are described in the specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such development effort might be complex and time-consuming, but would nevertheless be a routine undertaking for those of ordinary skill in the art having benefit of the disclosure herein.

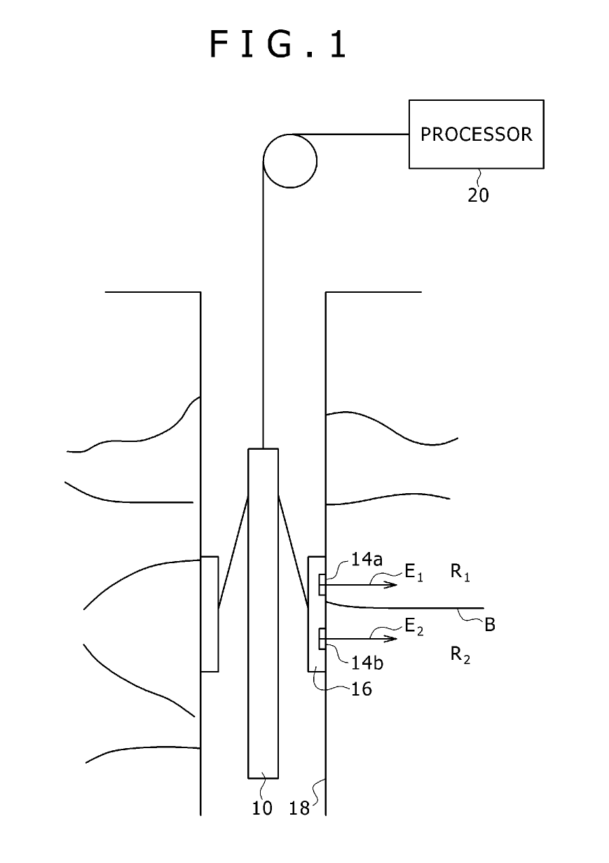

Referring now to FIG. 1, the borehole tool 10, which is applicable to a borehole imager pad tool for various types of measurements, such as a resistivity micro-imager tool, a micro-sonic imager tool or a corrosion imager tool in wellsite operations, includes an array of small survey electrodes (buttons) 14a-14b of a sensor mounted on a non-conductive pad 16 that is pressed against the borehole wall 18. For example, a current source is coupled to each button of the sensor such that current flows E1, E2 out of each button 14a-14b into the adjoining formation, perpendicular to the borehole wall 18. The current returns to an electrode (not shown) that is located at or near the surface of pad 16, or on another part of the tool 10.

The individual button currents are monitored and recorded (by an uphole processor 20) as the tool 10 is moved through the borehole, which includes a cased borehole and a drilled borehole before casing. The measured button currents are proportional to the conductivity of the formation material in front of each button. The measurements allow identification of features such as fractures B from interpretations of the images produced from the measurements. A further explanation of the generic structure and operation of the borehole tool with pads may be found in U.S. Pat. No. 4,862,090, U.S. Pat. No. 6,191,588, U.S. Pat. Application Publication No. US 2007/0193776, U.S. Pat. Application Publication No. US 2007/0290689 which are incorporated herein by reference in its entirety.

In the previous design of borehole tools with pads, the circumferential width of each pad was usually almost constant. Accordingly, the circumferential coverage of pads with respect to the inner wall of the borehole decreased as the borehole diameter increased. For example, the circumferential coverage of pads decreases from about 80% at a closed position (each pad closely adjacent to other pads on either side) to about 22% at the open position for a large borehole diameter (as the pads are moved outward to contact the borehole wall, the spacing of the pads to one another is increased).

Furthermore, referencing the previous design of borehole tools with pads, it was desirable to allow the borehole tool to be smoothly moved along the longitudinal axis of the borehole without any sticking or damage to the tool, even when being used in a deviated well. To address at least some of the problems associated with coverage while retaining the capability for smooth movement of the borehole tool, embodiments of the current disclosure include a plurality of pads with a rounded outer shape. In addition, each of the pads is mounted on an arm so as to be rotatable about a radial axis corresponding to the arm movement between a closed position and an open position. The rotation of the pads allows the outer curvature of the pads to provide different circumferential coverage according to the azimuth with respect to the longitudinal axis of the borehole.

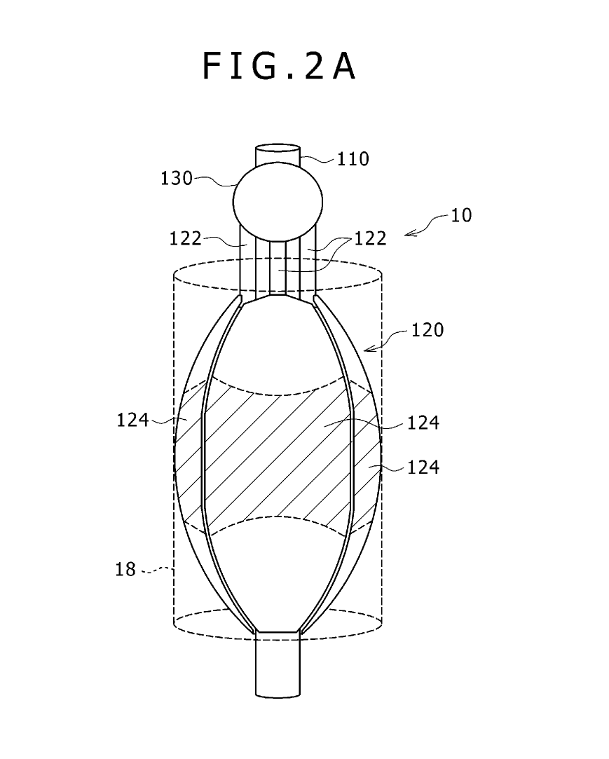

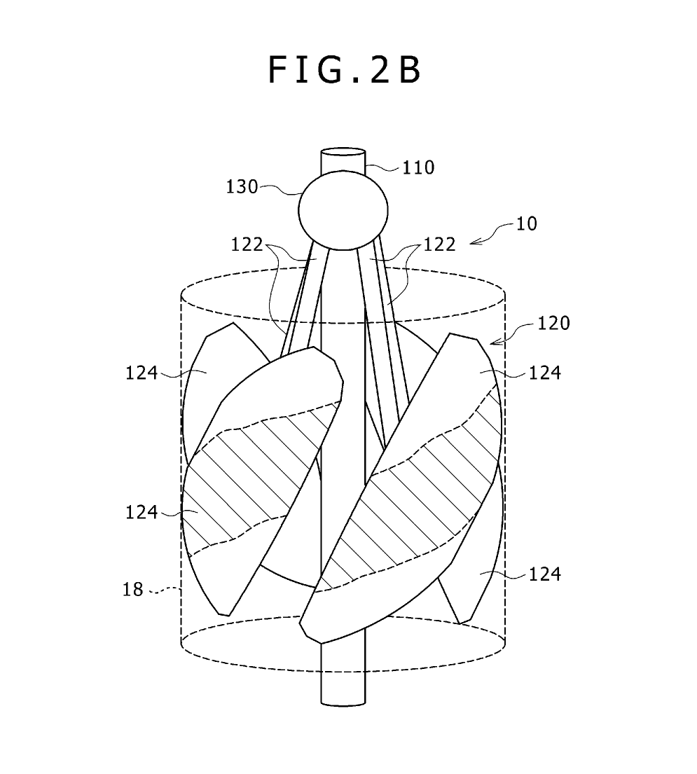

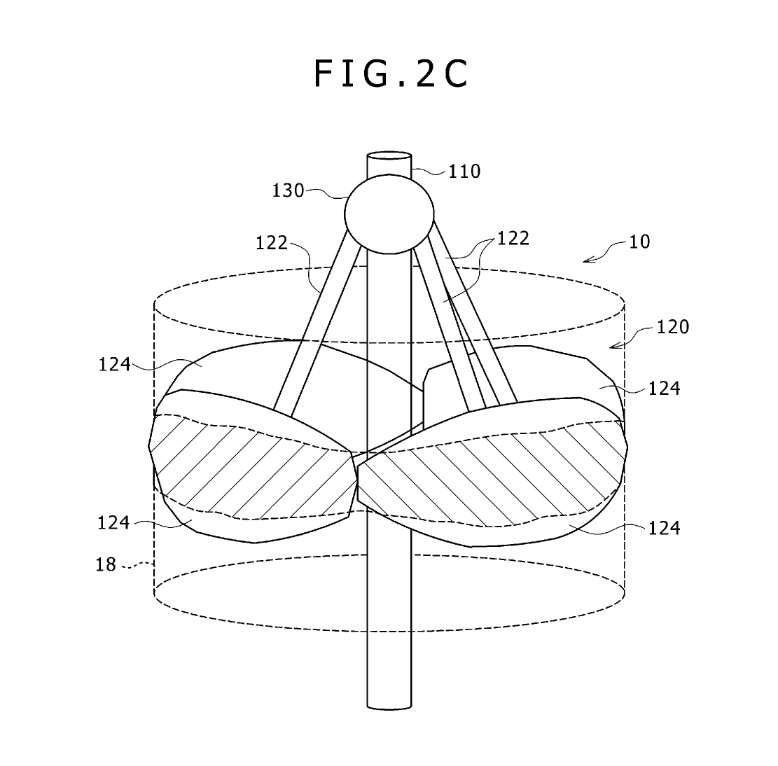

The borehole tool 10 according to one exemplary embodiment of the disclosures herein is generally shown in FIGS. 2A-2C. The borehole tool 10 comprises a tool body 110 and one set of movable pad sections 120 (i.e., three movable pads can be expressly seen in the view shown in FIG. 2A but four would actually be present in this exemplary embodiment). The movable pad section 120 includes N arms 122 and N pads 124 (e.g., in this embodiment N=4). The number N of the arms 122 and the pads 124 may be 2, 3 or more than 4 in other embodiments.

The arms 122 are connected to the tool body 110 by using an arm open/close mechanism 130 so as to be movable radially relative to the central axis of the tool. The arms 122 may be moveable between a fully closed position shown in FIG. 2A and a fully open position shown in FIG. 2C. The fully closed position would correspond to the smallest diameter borehole specified for the borehole tool 10 and the fully open position would correspond to the largest diameter borehole specified for the borehole tool 10. A range of various diameters of boreholes may be accommodated between the fully closed and fully opened positions.

As shown in FIG. 2B, the borehole tool 10 is located in a borehole the diameter of which is halfway between the open and closed positions. The arms 122 may be moved via a variety of mechanisms, for example, a hydraulic controlling mechanism, an electrical motor or a spring. In some embodiments, the arms 122 may be moved synchronously with each other while in other embodiments the arms 122 may be moved independently from one another.

The pads 124 have a rounded outer shape composed of different radii of curvature at different orientations across the surface of the pads 124. For example, at the fully closed position shown generally in FIG. 2A, each of the pads 124 forms an N (in this case N=4) outer surface portion with a radius of curvature across the center of the pads 124 (i.e., orthogonal to the longitudinal axis of the tool) of almost same contour as the smallest diameter specified for operation of the borehole tool 10. The shape across this orientation of the pads 124 is nearly equally divided with respect to circumferential direction about the longitudinal of tool body 110. The rounded outer shape of the pads 124 allows that the borehole tool 10 to smoothly move along the longitudinal axis of the borehole 18 even when being used in deviated wells. As will be seen in discussion of the other orientations of the pads 124, the total outer shape of the pads 124 may be configured as an almost ovoid or prolate spheroidal shape.

The pads 124 are adjacently arranged such that each of the pads 124 is located at different angle range of 360°/N in the circumferential direction about the longitudinal axis of the tool body 110. In the exemplary embodiment shown in FIGS. 2A-2C, since N is equal to 4, each pad is located approximately 90° from an adjacent pad. This arrangement of pads 124 provides different circumferential coverage according to the azimuth with respect to the longitudinal axis of the borehole 18.

Each of the pads 124 is mounted on a movable portion of the arms 122 so as to be rotatable about an axis orthogonal to the longitudinal axis of the tool body 110. In some embodiments, the rotation of a pad 124 about the orthogonal axis begins at 0° (when the arm movement is located in the fully closed position as seen in FIG. 2A) and ends at 90° (when the arm movement corresponds to the fully open position as seen in FIG. 2C). For this embodiment, the pad 124 may be rotated between 0° and 90° for diameters of boreholes between the fully closed and fully opened position. For example, the pads 124 are rotated approximately 45° for the diameter of borehole associated with arm movement corresponding to the halfway position as seen in FIG. 2B.

In some cases, the pads 124 may be rotated by using a hydraulic controlling mechanism, however, any appropriate mechanism may be used, for example, an electrical motor or a spring among others. Although the pads 124 in the present embodiment appear to be rotated synchronously with the arm movement and synchronously with one another, and in the same rotation direction of clockwise about the orthogonal axis when the arms 122 move from a fully closed position to a fully open position, this is not a limitation of the disclosure.

As would be known to people of skill in the art, in embodiments of this disclosure the pads 124 may be rotated synchronously with each other in the same rotating direction of counterclockwise or independently from each other. While still in other embodiments, the pads 124 may be rotated independently from the arm movement. For example, the arms 122 may be extended to contact the surface of the borehole wall, and the pads 124 rotated into a position such that the curvature of the outer surface of the pad 124 corresponds with the inner surface of the borehole wall.

The hatched areas shown on the pads 124 in FIGS. 2A-2C generally indicate the approximate pad surface portion that is in contact with the borehole inner surface. Of course, the outer surface of the pads 124 may not correspond directly with the borehole inner surface, some degree of standoff is expected and within the scope of this disclosure. In some cases, a standoff may have an acceptable tolerance (for example less than 3 mm). Because practically it is not necessary to perfectly match with the borehole inner surface, electrical and acoustic measurements can tolerate a standoff.

In FIG. 2A, the arms 122 are closed and shown with a longitudinal direction almost parallel to the vertical direction of the figure (i.e., approximately 0° of rotation). This pad 124 configuration would correspond to the smallest borehole diameter specified for the borehole tool 10. In FIG. 2B, the pads 124 are shown with arms 122 halfway open and the pads 124 have rotated according to the arm movement (i.e., approximately 45°). This particular pad configuration would correspond to a medium-sized borehole diameter. In FIG. 2C, the arms 122 are fully open and the pads 124 are fully rotated. This pad configuration corresponds to the maximum borehole size for which this tool architecture provides 100% coverage (i.e., approximately 90° of rotation for the pads 124). In this way, the present pad configuration in the disclosure herein is suitable for a full borehole pad imager in which the pads 124 match the surface sensor with the borehole inner surface by a simple rotating of the pads 124 such that the sum of diagonal of the sensors matching the borehole inner surface forms an effectively or virtually continuous line (but not necessarily physically continuous) and assures a full coverage of the borehole inner surface.

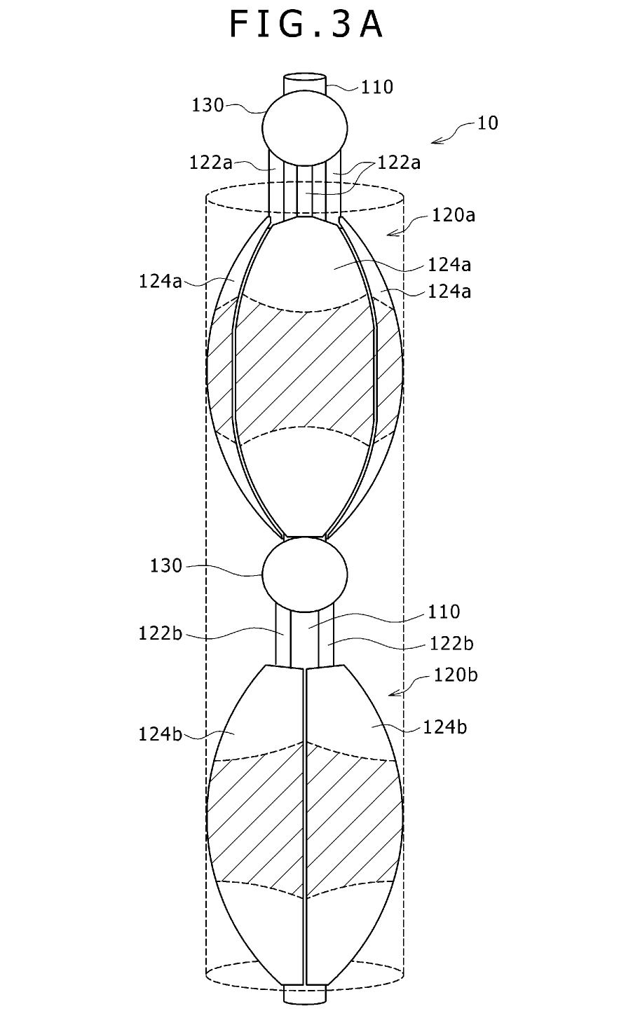

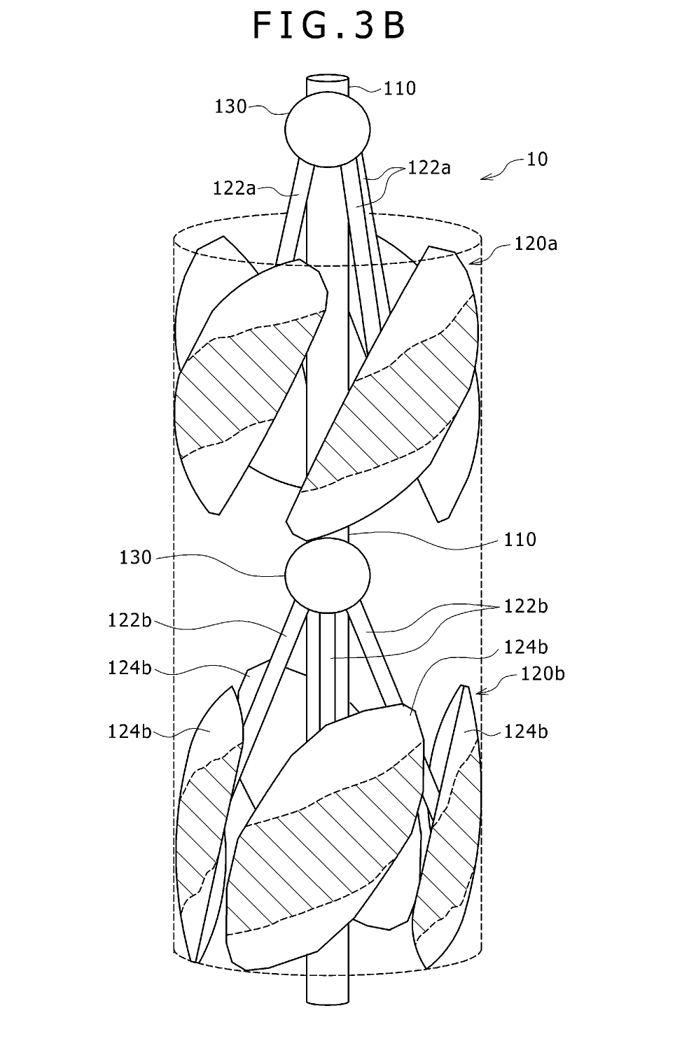

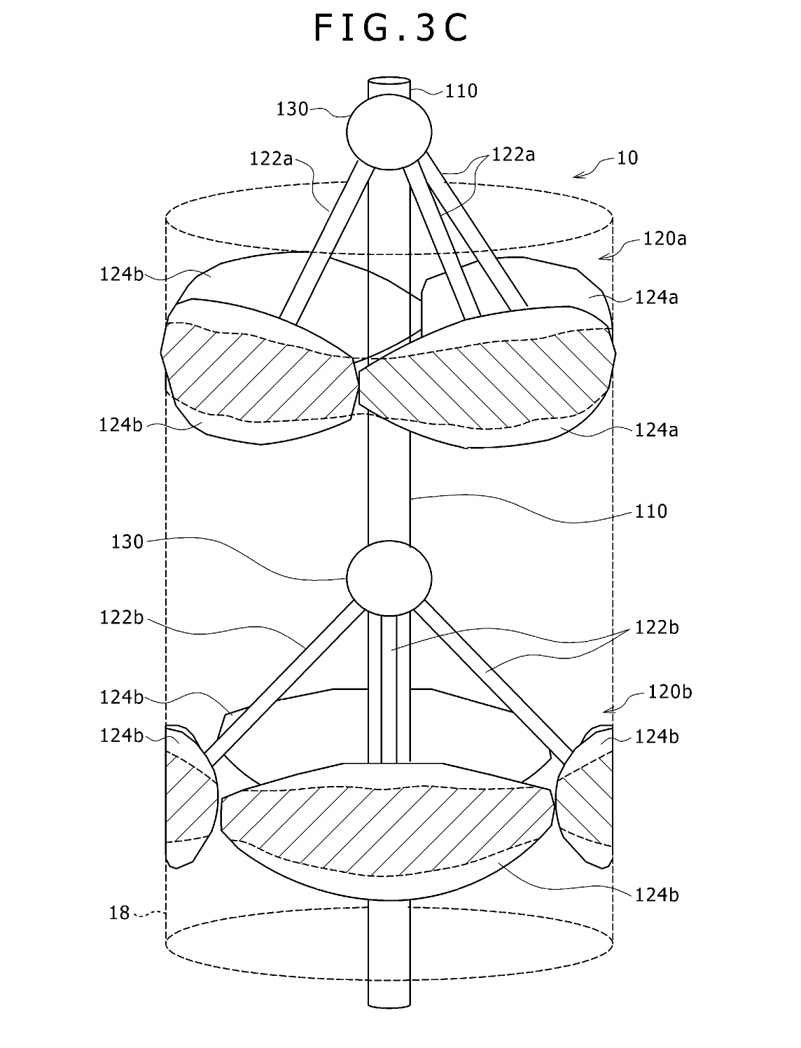

Variations can be made which provide more flexibility to the deployment or in order to provide locations to deploy additional measurement sensors. A further embodiment is generally shown in exemplary FIGS. 3A-3C. In these figures, the borehole tool 10 comprises M sets (e.g., two sets are shown so in this case M=2) of the movable pad sections 120a and 120b. The number M of the movable pad sections 120 may be more than 2 in other embodiments. The N pads (e.g., in this case N=4) 124b mounted on the arms 122b in the lower set 120b are azimuthally offset from the N pads 124a mounted on the arms 122a in the upper set 120a by 180°/N (45°), which is a half of the angle between the adjacent pads of a given set.

Since in some cases, there may be a slight discontinuity between adjacent pads 124 or the borehole inner surface wall may not be entirely cylindrical, gaps in coverage by the pads 124 can exist around the circumference of the borehole tool 10. Accordingly, embodiments with 2 or more sets of the movable pad sections 120 are capable of fully covering or providing a redundancy to the operation and measurement of another set by enabling the full azimuthal coverage within an acceptable tolerance of fit both surfaces of the pads 124 and the borehole 18.

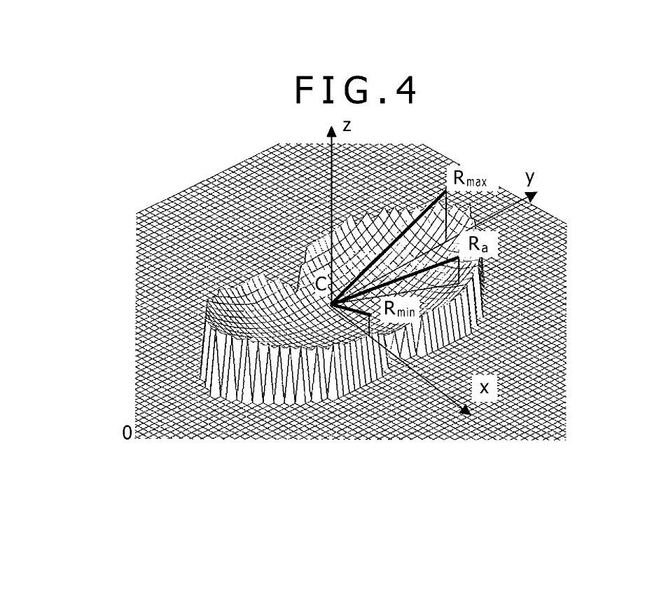

The surface of the pads 124 may be configured according to a mathematical model shown in FIG. 4. In FIG. 4, the z-axis represents the orthogonal axis to the longitudinal axis of the borehole tool 10, about which the pad 124 is rotated. The model is intended to design an outer surface configuration for a pad 124 that provides an approximate fit for the inner surface of boreholes with diameters from Rₘᵢₙ up to Rₘₐₓ. A bisection between the angle α for the azimuth (orientation) of a pad element and the radius R of borehole is represented by the following formula:

$$α = \frac{π}{2} \times \frac{R - {R}_{min}}{{R}_{max} - {R}_{min}} \qquad ( 1 )$$

or inversely:

$$R = {R}_{min} + \frac{α}{\frac{π}{2}} ( {R}_{max} - {R}_{min} ) \qquad ( 2 )$$

The contour M of the pad elements is defined with the following relation (3) by considering the number N of pad elements (sensors) distributed along the azimuth to ensure the full coverage where (Pa) is the plane belonging to the borehole inner surface.

$$∀ M ( x , y , z ) ∈ Element ⋂ ( {P}_{α} ) , \sqrt{{x}^{2} + {y}^{2}} < {R}_{α} \times sin ( \frac{2 π}{N} ) \qquad ( 3 )$$

In above-described embodiments, at least one of the number N and shape of pads 124 may be determined by the range of internal sizes of the borehole 18, the overlap percentage of coverage between the adjacent pads, and the outer size of borehole tool 10. At least one of the number N and the shape of pads 124 may be also determined due to the conditions or constraints associated with the sensor and measuring with the sensor installed on the pad 124, such as the sensor button size, current injector for the borehole tool 10, and induction loops alignment for corrosion tools, among others.

The pad configuration according to embodiments of the disclosures herein may be applied to a resistivity micro-imager tool, a micro-sonic imager tool or a corrosion imager tool, among others for example.

The preceding description has been presented only to illustrate and describe certain exemplary embodiments. It is not intended to be exhaustive or to limit the disclosures to any precise form disclosed. Many modifications and variations are possible in light of the above teaching.

The embodiments and aspects were chosen and described in order to best explain principles of the disclosures and its practical applications. The preceding description is intended to enable others skilled in the art to best utilize the principles in various embodiments and aspects and with various modifications as are suited to the particular use contemplated. It is intended that the scope of the disclosures be defined by the following claims.

What is claimed is:

1. A borehole tool used in a borehole, comprising:
a tool body;
a plurality of arms connected to the tool body so as to be movable radially relative thereto between a fully closed position and a fully open position;
a plurality of pads with a rounded outer shape, each of the pads being mounted on each movable portion of the arms so as to be rotatable about a radial axis relative to the tool body according to the arm movement between the fully closed position and the fully open position; and
wherein the plurality of pads provide substantially continuous circumferential coverage for a range of internal sizes of the borehole corresponding to the fully closed position and the fully open position.

2. The borehole tool according to claim 1, wherein the plurality of pads are adjacently arranged so as to provide different circumferential coverage according to the azimuth with respect to the longitudinal axis of the borehole.

3. The borehole tool according to claim 1, wherein the total outer shape of the plurality of pads at the closed position is an almost ovoid or prolate spheroidal shape.

4. The borehole tool according to claim 1, wherein at least one of the number and shape of pads is determined by the range of internal size of the borehole.

5. The borehole tool according to claim 1, wherein at least one of the number and shape of pads is determined by the overlap percentage of coverage between the adjacent pads.

6. The borehole tool according to claim 1, wherein at least one of the number and shape of pads is determined by the outer size of borehole tool.

7. The borehole tool according to claim 1, wherein at least one of the number and shape of pads is determined by conditions or constraints of measuring with a sensor installed on the pad.

8. The borehole tool according to claim 1, wherein the plurality of pads is adjacently arranged such that each of the pads is located at different angle range in the circumferential direction about the longitudinal axis of the tool body.

9. The borehole tool according to claim 1, wherein two or more sets of the plurality of pads are arranged to provide different coverage geometry.

10. The borehole tool according to claim 1, wherein the plurality of pads is rotated synchronously with the arm movement.

11. The borehole tool according to claim 1, wherein the plurality of pads is rotated independently from the arm movement.

12. The borehole tool according to claim 1, wherein the plurality of pads is rotated synchronously with each other.

13. The borehole tool according to claim 1, wherein the plurality of pads is rotated independently from each other.

14. The borehole tool according to claim 1, wherein the plurality of pads is rotated in the same rotating direction of clockwise or counterclockwise about the radial axis.

15. The borehole tool according to claim 1, wherein the plurality of arms is moved synchronously with each other.

16. The borehole tool according to claim 1, wherein the plurality of arms is moved independently from each other.

17. The borehole tool according to claim 1, wherein the plurality of pads is rotated by using a hydraulic controlling mechanism, an electrical motor or a spring.

18. The borehole tool according to claim 1, wherein the plurality of arms is moved by using a hydraulic controlling mechanism, an electrical motor or a spring.

19. A borehole tool used in a borehole, comprising:
a tool body;
a first set of sensors comprising:
a first plurality of arms connected to the tool body so as to be movable radially relative thereto between a fully closed position and a fully open position;
a first plurality of pads with a rounded outer shape, each of the pads being mounted on each movable portion of the arms so as to be rotatable about a radial axis relative to the tool body according to the arm movement between the fully closed position and the fully open position;
a second set of sensors comprising:
a second plurality of arms connected to the tool body so as to be movable radially relative thereto between a fully closed position and a fully open position;
a second plurality of pads with a rounded outer shape, each of the pads being mounted on each movable portion of the arms so as to be rotatable about a radial axis relative to the tool body according to the arm movement between the fully closed position and the fully open position;
wherein the first set of sensors is rotated about a longitudinal axis of the borehole tool with respect to the second set of sensors; and
wherein the first and second plurality of pads provide substantially continuous circumferential coverage for a range of internal sizes of the borehole corresponding to the fully closed position and the fully open positions.

20. Performing a borehole survey using a bore hole tool, comprising:
providing the borehole tool comprising:
a tool body;
a plurality of arms connected to the tool body so as to be movable radially relative thereto between a fully closed position and a fully open position;
a plurality of pads with a rounded outer shape, each of the pads being mounted on each movable portion of the arms so as to be rotatable about a radial axis relative to the tool body according to the arm movement between the fully closed position and the fully open position; and
wherein the plurality of pads provide substantially continuous circumferential coverage for a range of internal sizes of the borehole corresponding to the fully closed position and the fully open position;
passing a current, out of a plurality of sensors located on the plurality of pads, into a formation surrounding a borehole;
measuring a current into the plurality of sensors; and
identifying features of the formation from the measure current into the plurality of sensors.
